(19) United States
(12) Patent Application Publication
(10) Pub. No.: US 2023/0351335 A1
(43) Pub. Date: Nov. 2, 2023

(54) EMPLOYEE INTERACTION ASSISTANT

(71) Applicant: Microsoft Technology Licensing, LLC, Redmond, WA (US)

(72) Inventors: Satish CHANDRA, Bothell, WA (US); Yaming LIU, Sammamish, WA (US); Manish RAJANGAM, Seattle, WA (US); Rahul KUMAR, Snohomish, WA (US); Avneesh RAI, Bellevue, WA (US); Andrew ZHANG, Bellevue, WA (US); Shuming SUN, Seattle, WA (US); Saleha Iqbal HUSSAIN, Redmond, WA (US); Swati SHARMA, Bellevue, WA (US); Akash RATHORE, Dallas, TX (US)

(21) Appl. No.: 17/733,621

(22) Filed: Apr. 29, 2022

(51) Int. Cl. G06Q 10/10; G06Q 10/06; G06N 20/00

(52) U.S. Cl. CPC G06Q 10/1095; G06Q 10/1091; G06Q 10/06311; G06N 20/00

(57) ABSTRACT

The systems and methods provide assistance in employee interactions. The systems and methods automatically schedule meetings between a manager and a report in response to changes in human resource data. The systems and methods track the meetings between the manager and the report during a time period and obtain meeting minutes for the meetings. The systems and methods analyze the meeting minutes and automatically generate feedback based on the analysis of the meeting minutes. The feedback is provided to the report or the manager.

### BACKGROUND

A healthy interaction between employees is crucial for the success of the team and the projects of the team. There are several pain points for managers in trying to connect with new employees that report to the managers and maintain the progress of the employees. Managers and employees missing connection meetings are a common occurrence in an organization. When managers and/or the employees are working remote, it becomes difficult for managers and employees to connection with each other. In addition, when managers have many employees reporting to them, it becomes more difficult for the managers and the employees to meet with each other.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes receiving a notification indicating a change in human resource data for a report, wherein the change in human resource data includes the report joining a team of a manager. The method includes automatically obtaining calendar information for the manager and the report in response to the change in the human resource data. The method includes identifying, using a machine learning model, a timeslot for a meeting between the manager and the report based on the calendar information. The method includes automatically scheduling the meeting in the timeslot on a manager calendar for the manager and a report calendar for the report.

Some implementations relate to a device. The device includes one or more processors; memory in electronic communication with the one or more processors; and instructions stored in the memory, the instructions executable by the one or more processors to: receive a notification indicating a change in human resource data for a report, wherein the change in human resource data includes the report joining a team of a manager; automatically obtain calendar information for the manager and the report in response to the change in the human resource data; identify, using a machine learning model, a timeslot for a meeting between the manager and the report based on the calendar information; and automatically schedule the meeting in the timeslot on a manager calendar for the manager and a report calendar for the report.

Some implementations relate to a method. The method includes tracking a plurality of meetings between a manager and a report during a time period. The method includes obtaining meeting minutes for each meeting of the plurality of meetings. The method includes analyzing the meeting minutes of the plurality of meetings using a machine learning model. The method includes automatically generating feedback for the report or the manager based on analyzing the meeting minutes.

Some implementations relate to a device. The device includes one or more processors; memory in electronic communication with the one or more processors; and instructions stored in the memory, the instructions executable by the one or more processors to: track a plurality of meetings between a manager and a report during a time period; obtain meeting minutes for each meeting of the plurality of meetings; analyze the meeting minutes of the plurality of meetings using a machine learning model; and automatically generate feedback for the report or the manager based on analyzing the meeting minutes.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for providing assistance in employee interactions in accordance with implementations of the present disclosure.

FIG. 2 illustrates an example method for scheduling meetings in accordance with implementations of the present disclosure.

FIG. 3 illustrates an example method for generating feedback in accordance with implementations of the present disclosure.

FIG. 4 illustrates components that may be included within a computer system.

### DETAILED DESCRIPTION

This disclosure generally relates to providing assistance in employee interactions. A healthy interaction between a manager and reports (e.g., employees that report to the manager) is crucial for the success of the team and the projects of the team. New employees regularly join organizations and/or employees move between different teams within an organization. There are several pain points for managers in trying to connect with new reports (e.g., new employees to the organization or new employees to the team) and maintain the progress of the new reports. Managers and reports missing connection meetings are a common occurrence in an organization.

When managers and/or the reports are working remote, it becomes difficult for managers and reports to connection with each other. In addition, when managers have many employees reporting to them, it becomes more difficult for the managers and the employees to meet with each other. For example, in some organizations, managers have up to fifty employees reporting to the managers. As such, identifying available time in the manger's schedules for the individual meetings with the employees becomes difficult.

Nearly every company follows a schedule for a year-end feedback exchange between managers and their reports. Typically, recent events primary drive the feedback process. The most recent successes or failures takes the front seat in feedback while the goal is usually to aggregate the full year's successes and failures, which is a tedious task for both the manager and the report to scan through their interactions for the full year to do justice with such an aggregation.

The present disclosure provides methods and systems that provide assistance in building interactions between a manager and reports (e.g., any employees that report to the manager). The methods and systems identify manager and report pairs and use calendar information and/or geo-location information of the manager or the report for helping provide healthy interactions between the manager and the reports and helping maintain work-life balance for both the manager and the report.

The methods and systems detect a change in human resource (HR) data with a new report reporting to the manager (e.g., a new hire, an individual joins a team). The methods and systems automatically schedule a meeting (or recurring meetings) with the manager and the new report in response to the change in human resource data. The meetings are automatically scheduled based on calendar availability and user profile information (preferences for meeting times, time zones, geographic locations of the users, etc.).

In some implementations, the meetings are one-on-one meetings (1:1 meetings) between the manager and the report that focus on the day-to-day activities of the report, career growth of the report, and future goals for the report. The methods and systems track every one-on-one meeting between the manager and the report throughout a period of time (e.g., a year or a review cycle). In some implementations, the methods automatically identify action items discussed during the meetings using machine learning of meeting transcripts or meeting notes. The methods and systems automatically create an aggregate summary of the meetings over the year for the report.

The summary may be used at the end of a review cycle to automatically create the end of cycle review to provide feedback to the report. The summary automatically captures the information provided throughout the year during the one-on-one meetings so that a summary of any report may be easily generated by the manager covering the achievements, goals, issues, and/or areas of improvement discussed throughout the year with the report.

The summary may track whether the report is performing the action items provided in the meetings (e.g., additional training) and whether the actions items are helping the performance of the report. The summary may also track the interactions between the report and the manager over the year to determine if the changes in the pairing may be necessary (e.g., the employee changes to a different manager or a different group).

The methods and systems may detect whenever a new employee has started reporting to a manager and sends a notification to the manager (via email, instant messaging (IM), or any other notification framework supported by the organization) to setup a new one-on-one meeting series with the report. The methods and systems may use geolocation information and/or calendar information of the manager and the report to automatically suggest a suitable time for the meeting. The methods and systems may take clues from other one-on-one meeting durations of the manager to automatically suggest similar duration for the meeting. The methods and systems makes it very easy to setup the meeting by pre-filling all the required details in a single click.

The systems and methods may detect whenever a report is no longer reporting to the manager (e.g., the employee left the company or switched to a different team). The systems and methods may send a notification to the manager notifying the manger that the report no longer reports to the manager and assists in deleting all the meeting occurrences with the report in a single click.

The systems and methods may evaluate meeting occurrences between the manager and report on a weekly basis and may delete meeting occurrences from the calendars of the manager and the report if the scheduled meeting happens to be on a holiday or if either of the individuals are out of office (OOF). The systems and methods may send early notifications about deleting the meeting from the calendars.

After the one-on-one meeting, the systems and methods may detect whether follow-ups from the meeting have occurred or are still outstanding. The systems and methods send a summary to the manager and/or the report of the meeting and identify if any action items resulted in the meeting that may need further tracking.

In some implementations, the systems and methods may collect feedback from both the managers and the reports after the one-on-one meeting. The feedback may be used in providing reviews (e.g., full year or half year performance reviews) and may be aggregated from the information gathered in the meetings. The manager may use the feedback to analyze the growth trajectory of the report. The information may also be used to provide feedback in yearly reviews, half yearly reviews, or during other meetings between the manager and the report. The feedback from the reports may be anonymized and aggregated for the full year or half year and made available to the manager or leadership as 360 degree feedback. The methods and systems also takes care of anonymization of information to establish privacy and at the same time provide enough data in the information for further improvements in the report or a relationship between the manager and the report.

One technical advantage of the methods and systems of the present disclosure is an intelligent way of consuming various disconnected actions or signals from a manager and report interactions at different points of their day-to-day work and stitching the actions or signals together to provide a helping hand to improve the partnership between a manager and a report. Another technical advantage of the methods and systems of the present disclosure is providing targeted assistance to improve productivity of the manager and the report. Another technical advantage of the methods and systems of the present disclosure is mining insights from the one-on-one meeting minutes and/or summary between every manager and/or report pair collected over a period of time. The insights may be provided at a team or group level or an organization level and may provide information into a level of collaboration and/or a level of happiness of employees.

As such, the methods and systems provide a meeting assistant component that helps in facilitating interactions between a manager and a report. The methods and systems automatically schedule meetings between the manager and the report (e.g., one-on-one meetings) and automatically capture the information provided throughout the year during the meetings so that a summary of any report can easily be generated by the manger covering the achievements, goals, and/or areas of improvements discussed throughout the year with the report during the meetings. The methods and systems helps in facilitating a healthy relationship between the manager and the report

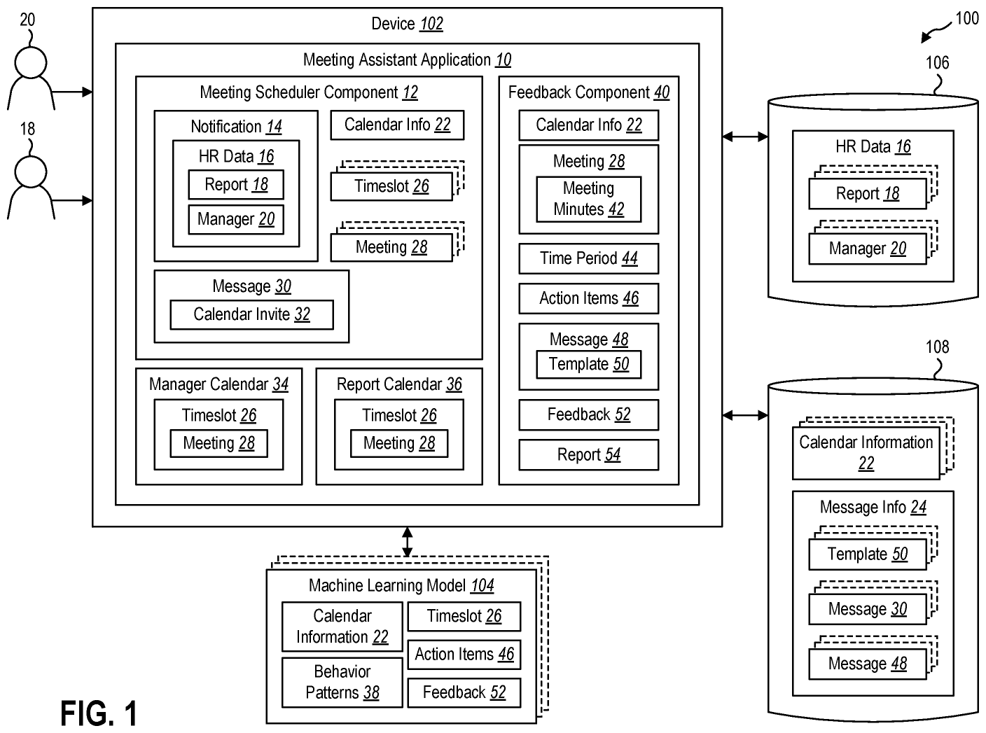

Referring now to FIG. 1, illustrated is an example environment 100 for providing assistance in employee interactions. Employees of an organization include managers 20 and reports 18. A report 18 is an employee that reports the manager 20. A manager 20 (also referred to as a supervisor) may have a team of employees who report to the manager 20 (e.g., the reports 18). For example, the manager 20 may own a particular area and the report 18 is an employee who works on that area under the manger 20 and is reporting to the manager 20. The environment 100 includes one or more devices 102 with a meeting assistant application 10 that provides assistance in interactions between manager(s) 20 and report(s) 18 that report to the manager(s) 20. The devices 102 may be accessed by the manager(s) 20 and/or the report(s) 18. The devices 102 may also be accessed by any user of the environment 100 (e.g., other employees in the organization). The meeting assistant application 10 aids in improving a productivity of the manager(s) 20 and the report(s) 18 day-to-day interactions.

The meeting assistant application 10 includes a meeting scheduler component 12 that automatically schedules meetings 28 between the manager 20 and the report 18 in response to receiving a notification 14 indicating a change in the human resource data 16. The notification 14 is sent via email, instant messaging (IM), or any other notification framework supported by the organization. A change in human resource data 16 includes a new report 18 joining an organization, the report 18 joining a team of the manager 20, and/or any association being created between the report 18 and the manager 20. As such, the human resource data 16 may identify new pairings between the managers 20 and the reports 18. A change in human resource data 16 also includes the report 18 leaving the organization or the report 18 leaving a team of the manager 20. The notification 14 may include employee information for the report 18, such as, a name of the report 18, an employee identification (ID) for the report 18, and/or office geographic location information for the report 18. The employee information may be obtained from a human resource system with one or more datastores 106 of human resource data 16. In some implementations, the notification 14 is generated by the human resource system in response to a reporting structure change for the report 18 or the manager 20.

In some implementations, the meeting 28 is a one-on-one meeting between the manager 20 and the report 18. A one-on-one meeting is a private meeting between the manager 20 and the report 18. Typically, the one-on-one meeting is used to discuss a growth plan of the report 18, any issues or grievance that the manager 20 and/or the report 18 wish to discuss among each other, discussions around project deliverables, and/or getting in consensus on expectations between the manager 20 and the report 18. The change in human resource data 16 triggers the meeting scheduler component 12 to automatically schedule the meeting 28 (e.g., the one-on-one meetings) on the manager calendar 34 and the report calendar 36.

The meeting scheduler component 12 obtains the calendar information 22 for the manager calendar 34 and the report calendar 36 from a datastore 108 and identifies one or more timeslots 26 for the meeting 28 based on the calendar information 22. The datastore 108 may store the calendar information 22 per employee (e.g., the managers 20 and the reports 18). The calendar information 22 includes geographic location information for the manager 20 and the report 18, time zone information for the manager 20 and the report 18, holiday information for the manager 20 and the report 18, out of office information for the manager 20 and the report 18, or any unavailable timeslots on the manager calendar 34 or the report calendar 36. The calendar information 22 also includes any scheduled meetings (e.g., recurring one-on-one meetings, recurring team meetings, or any other meetings) on the manager calendar 34 or the report calendar 36. In some implementations, the calendar information 22 is obtained for a time period (e.g., the next week or the next two weeks).

The meeting scheduler component 12 may use one or more machine learning models 104 to identify timeslots 26 for the meeting 28 in the manager calendar 34 and the report calendar 36. In some implementations, the machine learning model(s) 104 are separate from the device 102 and accessed by the meeting scheduler component 12 through different application programming interfaces (APIs).

The meeting scheduler component 12 provides the calendar information 22 to the machine learning model 104 as input to the machine learning model 104. The machine learning model 104 analyzes the calendar information 22 and identifies geographic location information for the manager 20 and the report 18. The machine learning model 104 analyzes the calendar information 22 and also determines any holidays or other restrictions for scheduling the meetings (e.g., out of office messages or other unavailable timeslots). A holiday in one individual's location may not match with holidays in the other individual's location. For example, the manager 20 may be in one country with holidays and the report 18 may be in a different country with different holidays from the manager 20.

In addition, the machine learning model 104 may learn behavior patterns 38 for the manager 20 and/or the report 18 based on analysis of the calendar information 22. The machine learning model 104 may analyze the calendar information 22 associated with previous meetings scheduled to learn different behavior patterns 38 of the manager 20 and/or the report 18 for scheduling meetings 28. Behavior patterns 38 may include a duration for the meetings 28. For example, the manager 20 typically schedules one-on-one meetings for thirty minutes. Behavior patterns 38 may include a preferred time of day for the meetings 28. One example includes the manager 20 typically schedules one-on-one meetings early in the morning. Another example includes the report 18 typically schedules one-on-one meetings near the end of the workday. Behavior patterns 38 may include preferred days for the meetings 28. For example, the manager 20 typically schedules one-on-one meetings on Friday. Behavior patterns 38 may include a preferred location for the meetings 28. One example includes the manager 20 typically schedules one-on-one meetings at a cafe or offsite from the organization. Another example includes the manager 20 typically schedules one-on-one meetings in a conference room. Another example includes the manager 20 typically schedules one-on-one meetings virtually. As such, the machine learning model 104 receives the calendar information 22 as input and identifies trends and/or patterns in the calendar information 22 to learn the behavior patterns 38.

The machine learning model 104 uses the calendar information 22 and the behavior patterns 38 to identify one or more timeslots 26 for the meeting 28. The timeslots 26 selected may be tailored based on the behavior patterns 38 learned by the machine learning model 104. In addition, the timeslots 26 selected may be based on the restrictions for the meetings (e.g., holidays, out of office, unavailable blocks of time), the geographic locations, and/or different time zones of the individuals.

The machine learning model 104 may identify a plurality of timeslots 26 for a single meeting 28 or for recurring meetings 28. The timeslots 26 include available blocks of time (e.g., thirty minutes, an hour, two hours) on both the manager calendar 34 and the report calendar 36 at the same time. The timeslots 26 received from the machine learning model 104 may be ranked or placed in an order. For example, the timeslots 26 are ranked based on user preferences and timeslots 26 that correspond to the manager's 20 learned behavior are ranked higher relative to other timeslots 26. Another example includes the timeslots 26 ranked based time zones and timeslots 26 available during the workday in different time zones are ranked higher relative to timeslots 26 available outside of the workday.

The meeting scheduler component 12 may automatically select a top ranked timeslot 26 for the meeting 28 and schedule the meeting 28 during the selected timeslot 26. In an implementation, the meeting scheduler component 12 may propose the plurality of timeslots 26 to the manager 20 and the manager 20 selects a timeslot 26 for the meeting 28. In addition, the meeting scheduler component 12 may select a plurality of timeslots 26 and schedule recurring meetings 28 between the manager 20 and the report 18 during the plurality of timeslots 26. For example, the meetings 28 are scheduled monthly. Another example includes the meetings 28 are scheduled weekly or bi-weekly. Another example includes the meetings 28 are scheduled quarterly.

In some implementations, the meeting scheduler component 12 provides a single click experience to assist in setting up the meetings 28 at the timeslot 26 in response to receiving the notification 14 indicating the change in the human resource data 16. The meeting scheduler component 12 may generate a message 30 (e.g., an email message or text message) with a calendar invite 32 to the manager 20. The manager 20 may receive the message 30 and provide a single click or selection to schedule the meeting 28 and send the calendar invite 32 to the report 18. As such, the manager 20 may click on a button or a link and the message with the calendar invite 32 is opened so that the manager 20 may review the message 30 and hit send with minimal steps to schedule the meeting 28 with the report 18.

The meeting scheduler component 12 may keep the manager calendar 34 and/or the report calendar 36 clean by removing any scheduled meetings 28 where an individual may not be available for the scheduled meetings 28. The meeting scheduler component 12 may receive updated calendar information 22 for the manager 20 and the report 18 and may determine that the manager 20 or the report 18 is unavailable during the scheduled meetings 28 using the updated calendar information 22. For example, if the manager 20 or the report 18 is scheduled for leave on the same day that the meeting 28 is scheduled for, the meeting scheduler component 12 may automatically remove the meeting 28 from the manager calendar 34 and the report calendar 36 in response to identifying the scheduled leave at the same time as the meeting 28. Another example includes if the manager 20 or the report 18 is scheduled for leave on the same day that the meeting 28 is scheduled for, the meeting scheduler component 12 may automatically move the meeting 28 to a next available timeslot 26 on the manager calendar 34 and the report calendar 36.

The meeting scheduler component 12 may also remove any meetings 28 associated with the manager 20 and the report 18 in response to receiving a notification 14 indicating that the report 18 moved to a different manager or the report 18 is no longer with the organization (e.g., a change in human resource data 16 occurred) to clean up the manager calendar 34 and the report calendar 36 by making more timeslots available. By cleaning up the timeslots by removing the meetings 28 in response to the change in the human resource data 16, the manager 20 and/or the report 18 may plan their days better and/or may use the available timeslots in a productive manner.

As such, the changes in the human resource data 16 triggers the meeting scheduler component 12 to schedule the meetings 28 on the manager calendar 34 and the report calendar 36 and/or remove the meetings 28 from the manager calendar 34 and the report calendar 36.

The meeting assistant application 10 also has a feedback component 40. The feedback component 40 tracks each meeting 28 scheduled between the manager 20 and the report 18 over a time period 44. The time period 44 may be a review cycle (e.g., six months or a year). In some implementations, the meetings 28 are one-on-one meetings between the manager 20 and the report 18 that discuss the day-to-day activities of the report 18 and the career path of the report 18.

The feedback component 40 obtains meeting minutes 42 for the meeting 28. In some implementations, the feedback component 40 automatically obtains the meeting minutes 42 from transcripts generated of the meeting 28. For example, if the one-on-one meeting between the manager 20 and the report 18 occurred virtually using a communication application, the communication application may automatically generate a transcript of the one-on-one meeting. The transcripts may be used as the meeting minutes 42 for the meeting 28. As such, the meeting minutes 42 may be obtained by the feedback component 40 automatically without additional information provided by the manager 20 or the report 18 after completion of the meeting 28.

In some implementations, where the meeting 28 occurs in person or without the use of a device, the feedback component 40 may automatically send a message 48 to the manager 20 and the report 18 upon completion of the meeting 28 for the meeting minutes 42. For example, the one-on-one meeting occurs over a cup of coffee and the feedback component 40 automatically sends an e-mail message to the report 18 and the manager 20 for the meeting minutes 42 upon completion of the one-on-one meeting. The feedback component 40 may receive calendar information 22 and may automatically send the message 48 at the end of the meeting 28 based on the calendar information 22.

The message 48 includes a template 50 with fields or prompts for the manager 20 and the report 18 to provide information for the meeting minutes 42. The information may include a progress of the report 18, projects the report 18 is working on, successes of the report 18, failures of the report 18, areas of improvement for the report 18, goals of the report 18, and/or any other information relating to the day-to-day activities of the report 18. The information may also include details about interactions between the manager 20 and the reports 18, details about how the manager runs the team, details relating to the responsiveness of the manager 20, and details generally relating to the sentiment around the manager 20 or the team. The template 50 may be obtained from the message information 24 stored in the datastore 108. In addition, the message information 24 may store details about the messages 30, 48 sent to the manager 20 and the report 18.

The feedback component 40 may use the calendar information 22 of the manager 20 and the report 18 to identify when the meetings 28 are scheduled. At the end of the timeslot 26 for the meeting 28, the feedback component 40 may automatically send the message 48 to the manager 20 and the report 18 with the template 50 for the meeting minutes 42. The feedback component 40 may send reminders to the manager 20 and the report 18 within a timeframe of the meeting 28 (e.g., next day or two days) to provide the meeting minutes 42 if not previously provided by the manager 20 and the report 18.

The feedback component 40 may use the machine learning model 104 for analyzing the meeting minutes 42. In some implementations, the machine learning models 104 are accessed by the feedback component 40 through different APIs. In some implementations, the machine learning model 104 is a natural language processing model (e.g., Bidirectional Encoder Representations from Transformers (BERT) models) that analyzes the text of the meeting minutes 42.

The machine learning model 104 may analyze the text of the meeting minutes 42 and automatically identifies any action items 46 in the meeting minutes 42 based on words or phrases in the text of the meeting minutes 42. The action items 46 may include any suggestions for the report 18 and/or the manager 20 for tasks to perform or actions to take after the meeting 28. One example action item 46 includes reaching out to a specific individual for assistance or help. Another example action item 46 includes providing suggestions for further training (e.g., attending a conference, taking a class, learning more about a technology, taking a management class, or taking management training).

The machine learning model 104 may automatically generate feedback 52 for the report 18 or the manager 20 based on the analysis of the meeting minutes 42. The feedback 52 may provide a summary of the meeting minutes 42 over the time period 44. The summary may be based on analysis of the words or phrases in the text of the meeting minutes 42 by the machine learning model 104. One example of the feedback 52 includes highlighting the areas where the report 18 is doing a good job. Another example of the feedback 52 includes identifying areas of improvement for the report 18. Another example of the feedback 52 includes goals achieved by the report 18. Another example of the feedback 52 includes sentiment of the project or the manager 20. Another example of the feedback 52 includes whether the relationship between the manager 20 and the report 18 is healthy. As such, the feedback 52 provides a summary targeting each individual (the manager 20 and the report 18) for the time period 44.

The machine learning model 104 consolidates the meeting minutes 42 from each of the meetings 28 between the manager 20 and the report 18 to generate a holistic view of the report 18 or the manager 20 during the time period 44. By using the meeting minutes 42 from throughout the time period 44, the feedback 52 may provide an aggregation of information spanning the entire time period 44 and a holistic view of performance of the report 18 or the manager 20.

The feedback component 40 may automatically track the progress of the action items 46. One example includes the feedback component 40 using the calendar information 22 to identify any tasks associated with the action items 46 and whether the tasks are complete or outstanding. Another example includes the feedback component 40 using the calendar information 22 to identify meetings schedule or conferences scheduled based on the action items 46 (e.g., meetings scheduled with the recommended individual, or the recommended conferences scheduled). Tracking the progress of the action items 46 aids the manager 20 and/or the report 18 in planning future projects or work and whether the planning helped the report 18.

The feedback component 40 may automatically generate one or more reports 54 using the feedback 52 and/or the progress of the action items 46. The report(s) 54 may be given to the report 18 or the manager 20 with the feedback 52 and/or the progress of the action items 46 as part of a review process (e.g., end of year review or half year review). The report(s) 54 may also be generated on demand. For example, if the report 18 is transitioning to a new team, the report(s) 54 may be provided with the feedback 52 and/or the progress of the action items 46 as part of the transition process to the new team.

By continuing to accumulate the action items 46, the meeting minutes 42, and/or relevant conversations during the meetings 28 (e.g., the one-on-on meetings between the manager 20 and the report 18) throughout the time period 44, the report(s) 54 may easily provide the manager 20 and the report 18 and automatic aggregate summary of the report 18 or the manager 20 over the time period 44.

The feedback component 40 may maintain the data privacy of the report 18 and the manager 20. The feedback component 40 may apply different techniques to ensure that closed group conversations remain close group. For example, the feedback component 40 may identify the one-on-one meetings between the manager 20 and the report 18 and only obtain the meeting minutes 42 from the one-on-one meetings. Thus, the data from the other meetings 28 may remain private.

In some implementations, one or more computing devices (e.g., devices 102) are used to perform the processing of environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the meeting assistant application 10, the meeting scheduler component 12, the feedback component 40, the machine learning model(s) 104, and/or the datastore 106, 108 are implemented wholly on the same computing device. Another example includes one or more subcomponents of the meeting assistant application 10, the meeting scheduler component 12, the feedback component 40, the machine learning model(s) 104, and/or the datastore 106, 108 implemented across multiple computing devices. Moreover, in some implementations, the meeting assistant application 10, the meeting scheduler component 12, the feedback component 40, the machine learning model(s) 104, and/or the datastore 106, 108 are implemented or processed on different server devices of the same or different cloud computing networks. Moreover, in some implementations, the features and functionalities are implemented or processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

As such, the meeting assistant application 10 provides assistance in interactions between the manager(s) 20 and the report(s) 18 by automatically scheduling meetings 28 (e.g., one-on-one meetings) between the manager 20 and the report 18. In addition, the meeting assistant application 10 provides automatic summaries of the meetings 28 by analyzing the meeting minutes 42 obtained for the meetings 28. The summaries may be used to easily provide feedback 52 to the report 18 and/or the manager 20 during a review process or other transition process.

Thus, the meeting assistant application 10 aids in improving a productivity of the manager(s) 20 and the report(s) 18 day-to-day interactions. One example of improving productivity includes the manager 20 will not miss a one-on-one meeting with their reports 18. A manager 20 with over ten reports 18 may easily miss one-on-one meetings with their reports 18 without assistance. The meeting assistance application 10 aids in the manager 20 in scheduling the one-on-one meetings with their reports 18, and thus, improving the productivity of the mangers 20. Another example of improving productivity includes promoting the managers 20 and/or the reports 18 to capture discussions early using the meeting minutes 42. The manager 20 may talk to many individuals during the day and may miss capturing notes from the meetings 28 resulting in missing important topics that have been discussed during the meetings 28.

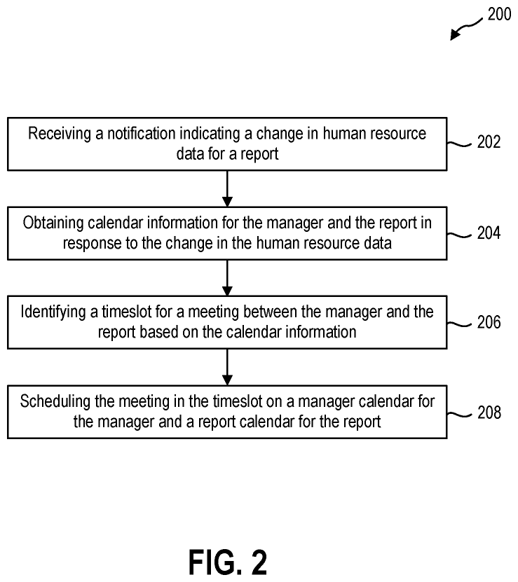

Referring now to FIG. 2, illustrated is an example method 200 for scheduling meetings 28 (FIG. 1). The actions of the method 200 are discussed below with reference to the architecture of FIG. 1.

At 202, the method 200 includes receiving a notification indicating a change in human resource data for a report. A meeting scheduler component 12 receives a notification 14 indicating a change in the human resource data 16. The notification 14 is sent via email, instant messaging (IM), or any other notification framework supported by the organization. In some implementations, the notification 14 is generated by the human resource system in response to a reporting structure change for the report 18 or the manager 20. The change in human resource data 16 also includes the report 18 joining a team of a manager 20 or the report 18 joining an organization. In addition, the change in human resource data 16 includes the report 18 leaving an organization or the report leaving the team of the manager 20.

At 204, the method 200 includes obtaining calendar information for the manager and the report in response to the change in the human resource data. The meeting scheduler component 12 obtains the calendar information 22 for the manager calendar 34 and the report calendar 36 from a datastore 108 in response to the change in the human resource data 16. The calendar information 22 includes geographic location information for the manager 20 and the report 18, time zone information for the manager 20 and the report 18, holiday information for the manager 20 and the report 18, out of office information for the manager 20 and the report 18, or any unavailable timeslots on the manager calendar 34 or the report calendar 36. The calendar information 22 also includes any scheduled meetings (e.g., recurring one-on-one meetings, recurring team meetings, or any other meetings) on the manager calendar 34 or the report calendar 36. In some implementations, the calendar information 22 is obtained for a time period (e.g., the next week or the next two weeks).

At 206, the method 200 includes identifying a timeslot for a meeting between the manager and the report based on the calendar information. The meeting scheduler component 12 identifies one or more timeslots 26 for the meeting 28 based on the calendar information 22. The timeslots 26 may be available time periods on both the manager calendar 34 and the report calendar 36. In some implementations, the meeting scheduler component 12 may use one or more machine learning models 104 to identify timeslots 26 for the meeting 28 in the manager calendar 34 and the report calendar 36.

The meeting scheduler component 12 provides the calendar information 22 to the machine learning model 104 as input to the machine learning model 104. The machine learning model 104 analyzes the calendar information 22 and identifies geographic location information for the manager 20 and the report 18. The machine learning model 104 analyzes the calendar information 22 and also determines any holidays or other restrictions for scheduling the meetings (e.g., out of office messages or other unavailable timeslots). In addition, the machine learning model 104 may learn behavior patterns 38 for the manager 20 and/or the report 18 based on analysis of the calendar information 22. The machine learning model 104 may analyze the calendar information 22 associated with previous meetings scheduled to learn different behavior patterns 38 of the manager 20 and/or the report 18 for scheduling meetings 28.

The machine learning model 104 uses learned behavior patterns 38 of the manager 20 from previous meetings and geographic location information for the manager 20 and the report 18 in identifying one or more timeslots 26 for the meeting 28. The machine learning model 104 may also determine holidays or out of office restrictions on the manager calendar 34 and the report calendar 36 and may use the holidays or the out of office restrictions in identifying one or more timeslots 26 for the meeting 28. The machine learning model 104 may also identify a plurality of timeslots 26 available for a single meeting 28 or for recurring meetings 28 based on the calendar information 22.

The timeslots 26 selected may be tailored based on the behavior patterns 38 learned by the machine learning model 104. In addition, the timeslots 26 selected may be based on the restrictions for the meetings (e.g., holidays, out of office, unavailable blocks of time), the geographic locations, and/or different time zones of the individuals.

The timeslots 26 received from the machine learning model 104 may be ranked or placed in an order. For example, the timeslots 26 are ranked based on availability during the workday in different time zones. The meeting scheduler component 12 may automatically select a top ranked timeslot 26 for the meeting 28 and schedule the meeting 28 during the selected timeslot 26. In an implementation, the meeting scheduler component 12 may propose the plurality of timeslots 26 to the manager 20 and the manager 20 selects a timeslot 26 for the meeting 28. In addition, the meeting scheduler component 12 may select a plurality of timeslots 26 for recurring meetings 28.

At 208, the method 200 includes scheduling the meeting in the timeslot on a manager calendar for the manager and a report calendar for the report. The meeting scheduler component 12 schedules the meeting 28 in the timeslot 26 on the manager calendar 34 and the report calendar 36. In some implementations, the meeting scheduler component 12 automatically schedules the meeting 28 in the timeslot 26 on the manager calendar 34 and the report calendar 36 in response to the change in human resource data 16. In some implementations, the meeting scheduler component 12 automatically schedules recurring meetings 28 in the plurality of timeslots on the manager calendar 34 and the report calendar 36 in a plurality of timeslots 26.

In some implementations, the meeting scheduler component 12 may automatically generate a message 30 (e.g., an email message or text message) with a calendar invite 32 to the manager 20. The manager 20 may receive the message 30 and provide a single click or selection to schedule the meeting 28 and send the calendar invite 32 to the report 18.

In some implementations, the meeting 28 is a one-on-one meeting between the manager 20 and the report 18. A one-on-one meeting focuses on day-to-day activities of the report 18, career growth of the report 18, and/or future goals for the report 18. The change in human resource data 16 triggers the meeting scheduler component 12 to automatically schedule the meeting 28 (e.g., the one-on-one meetings) on the manager calendar 34 and the report calendar 36.

The method 200 optionally includes the meeting scheduler component 12 automatically removing any scheduled meetings 28 between the manager 20 and the report 18 on the manager calendar 34 in response to the report 18 leaving the organization or the report 18 leaving the team of the manager 20.

As such, the method 200 may help in facilitating interactions between a manager 20 and a report 18 by automatically scheduling meetings 28 between the manager 20 and the report 18 in response to the changes in the human resource data 16.

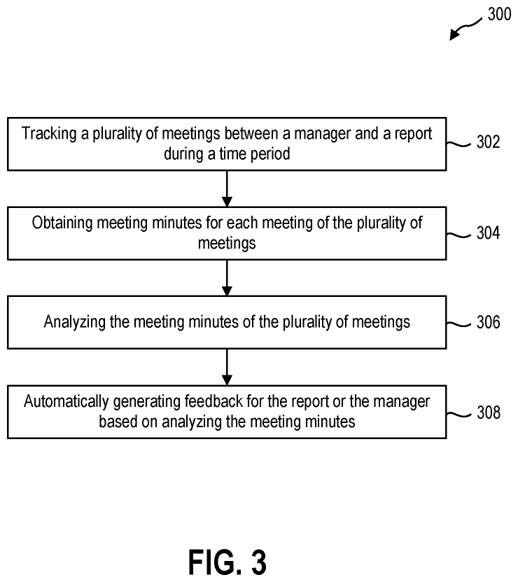

Referring now to FIG. 3, illustrated is an example method 300 for generating feedback 52 (FIG. 1). The actions of the method 300 are discussed below with reference to the architecture of FIG. 1.

At 302, the method 300 includes tracking a plurality of meeting between a manager and a report during a time period. The feedback component 40 tracks each meeting 28 scheduled between the manager 20 and the report 18 over a time period 44. The time period 44 may be a review cycle (e.g., six months or a year). In some implementations, the meetings 28 are one-on-one meetings between the manager 20 and the report 18 that discuss the day-to-day activities of the report 18 and the career path of the report 18. In some implementations, the meetings 28 are automatically scheduled in response to a change in human resource data 16 (e.g., the report 18 joining the team of the manager 20 or the report 18 joining an organization), as discussed above in FIGS. 1 and 2.

At 304, the method 300 includes obtaining meeting minutes for each meeting of the plurality of meetings. The feedback component 40 obtains meeting minutes 42 for the meeting 28. In some implementations, the feedback component 40 automatically obtains the meeting minutes 42 from transcripts generated of the meeting 28. For example, if the one-on-one meeting between the manager 20 and the report 18 occurred virtually using a communication application, the communication application may automatically generate a transcript of the one-on-one meeting. The transcripts may be used as the meeting minutes 42 for the meeting 28. As such, the meeting minutes 42 may be obtained by the feedback component 40 automatically without additional information provided by the manager 20 or the report 18 after completion of the meeting 28.

In some implementations, where the meeting 28 occurs in person or without the use of a device, the feedback component 40 may automatically send a message 48 to the manager 20 and the report 18 upon completion of the meeting 28 for the meeting minutes 42. For example, the one-on-one meeting occurs in an office and the feedback component 40 automatically sends an e-mail message to the report 18 and the manager 20 for the meeting minutes 42 upon completion of the one-on-one meeting. The feedback component 40 may receive calendar information 22 and may automatically send the message 48 at the end of the meeting 28 based on the calendar information 22.

The feedback component 40 may use the calendar information 22 of the manager 20 and the report 18 to identify when the meetings 28 are scheduled. At the end of the timeslot 26 for the meeting 28, the feedback component 40 may automatically send the message 48 to the manager 20 and the report 18. The message 48 includes a template 50 with fields or prompts for the manager 20 and the report 18 to provide information for the meeting minutes 42.

The information may include a progress of the report 18, projects the report 18 is working on, successes of the report 18, failures of the report 18, areas of improvement for the report 18, goals of the report 18, and/or any other information relating to the day-to-day activities of the report 18. The information may also include details about interactions between the manager 20 and the reports 18, details about how the manager runs the team, details relating to the responsiveness of the manager 20, and details generally relating to the sentiment around the manager 20 or the team. The template 50 may be obtained from the message information 24 stored in the datastore 108. The feedback component 40 may send reminders to the manager 20 and the report 18 within a timeframe of the meeting 28 (e.g., next day or two days) to provide the meeting minutes 42 if not previously provided by the manager 20 and the report 18.

At 306, the method 300 includes analyzing the meeting minutes of the plurality of meetings. The feedback component 40 may use the machine learning model 104 for analyzing the meeting minutes 42. In some implementations, the machine learning models 104 are accessed by the feedback component 40 through different APIs. In some implementations, the machine learning model 104 is a natural language processing model (e.g., Bidirectional Encoder Representations from Transformers (BERT) models) that analyzes the text of the meeting minutes 42.

The machine learning model 104 may analyze the text of the meeting minutes 42 and automatically identifies any action items 46 in the meeting minutes 42 based on words or phrases in the text of the meeting minutes 42. The action items 46 may include any suggestions for the report 18 and/or the manager 20 for tasks to perform or actions to take after the meeting 28. The machine learning model 104 may also analyze the text of the meeting minutes 42 aggregating a performance of the report or the manager during the time period from information provided in the meeting minutes.

At 308, the method 300 includes automatically generating feedback for the report or the manager based on analyzing the meeting minutes. The feedback component 40 may generate feedback 52 for the report 18 or the manager 20 based on the analysis of the meeting minutes 42.

In some implementations, the machine learning model 104 may automatically generate feedback 52 for the report 18 or the manager 20 based on the analysis of the meeting minutes 42. The feedback 52 may provide a summary of the meeting minutes 42 over the time period 44. The summary may be based on analysis of the words or phrases in the text of the meeting minutes 42 by the machine learning model 104. The machine learning model 104 consolidates the meeting minutes 42 from each of the meetings 28 between the manager 20 and the report 18 to generate a holistic view of the report 18 or the manager 20 during the time period 44. By using the meeting minutes 42 from throughout the time period 44, the feedback 52 may provide an aggregation of information spanning the entire time period 44 and a holistic view of performance of the report 18 or the manager 20.

The feedback component 40 may automatically track the progress of the action items 46. One example includes the feedback component 40 using the calendar information 22 to identify any tasks associated with the action items 46 and whether the tasks are complete or outstanding.

The feedback component 40 may automatically generate one or more reports 54 using the feedback 52 and/or the progress of the action items 46. The report(s) 54 may be given to the report 18 or the manager 20 with the feedback 52 and/or the progress of the action items 46 as part of a review process (e.g., end of year review or half year review). The report(s) 54 may also be generated on demand. For example, if the report 18 is transitioning to a new team, the report(s) 54 may be provided with the feedback 52 and/or the progress of the action items 46 as part of the transition process to the new team.

As such, the method 300 may be used to easily provide an automatic aggregate summary of the report 18 or the manager 20 over the time period 44 to use in providing feedback 52 to the report 18 or the manager 20.

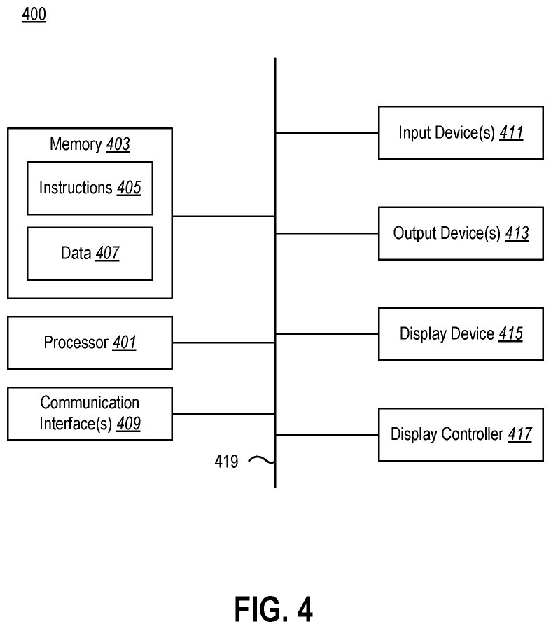

FIG. 4 illustrates components that may be included within a computer system 400. One or more computer systems 400 may be used to implement the various methods, devices, components, and/or systems described herein.

The computer system 400 includes a processor 401. The processor 401 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 401 may be referred to as a central processing unit (CPU). Although just a single processor 401 is shown in the computer system 400 of FIG. 4, in an alternative configuration, a combination of processors (e.g., an ARM and DSP) could be used.

The computer system 400 also includes memory 403 in electronic communication with the processor 401. The memory 403 may be any electronic component capable of storing electronic information. For example, the memory 403 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 405 and data 407 may be stored in the memory 403. The instructions 405 may be executable by the processor 401 to implement some or all of the functionality disclosed herein. Executing the instructions 405 may involve the use of the data 407 that is stored in the memory 403. Any of the various examples of modules and components described herein may be implemented, partially or wholly, as instructions 405 stored in memory 403 and executed by the processor 401. Any of the various examples of data described herein may be among the data 407 that is stored in memory 403 and used during execution of the instructions 405 by the processor 401.

A computer system 400 may also include one or more communication interfaces 409 for communicating with other electronic devices. The communication interface(s) 409 may be based on wired communication technology, wireless communication technology, or both. Some examples of communication interfaces 409 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 400 may also include one or more input devices 411 and one or more output devices 413. Some examples of input devices 411 include a keyboard, mouse, microphone, remote control device, button, joystick, trackball, touchpad, and lightpen. Some examples of output devices 413 include a speaker and a printer. One specific type of output device that is typically included in a computer system 400 is a display device 415. Display devices 415 used with embodiments disclosed herein may utilize any suitable image projection technology, such as liquid crystal display (LCD), light-emitting diode (LED), gas plasma, electroluminescence, or the like. A display controller 417 may also be provided, for converting data 407 stored in the memory 403 into text, graphics, and/or moving images (as appropriate) shown on the display device 415.

The various components of the computer system 400 may be coupled together by one or more buses, which may include a power bus, a control signal bus, a status signal bus, a data bus, etc. For the sake of clarity, the various buses are illustrated in FIG. 4 as a bus system 419.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving a notification indicating a change in human resource data for a report, wherein the change in human resource data includes the report joining a team of a manager;
automatically obtaining calendar information for the manager and the report in response to the change in the human resource data;
identifying, using a machine learning model, a timeslot for a meeting between the manager and the report based on the calendar information; and
automatically scheduling the meeting in the timeslot on a manager calendar for the manager and a report calendar for the report.

2. The method of claim 1, wherein automatically scheduling the meeting further includes:
automatically generating a message with a calendar invite for the meeting; and
sending the message to the manager to send to the report with the calendar invite for the meeting.

3. The method of claim 1, wherein the machine learning model uses learned behavior patterns of the manager from previous meetings and geographic location information for the manager and the report in identifying the timeslot.

4. The method of claim 1, wherein the machine learning model determines holidays or out of office restrictions on the manager calendar and the report calendar and uses the holidays or the out of office restrictions in identifying the timeslot.

5. The method of claim 1, further comprising:
identifying a plurality of timeslots for scheduling recurring meetings between the manager and the report based on the calendar information; and
automatically scheduling the recurring meetings in the plurality of timeslots on the manager calendar for the manager and the report calendar for the report.

6. The method of claim 5, wherein the change in human resource data includes one or more of the report leaving an organization or the report leaving the team of the manager, and the method further comprising:
automatically removing any scheduled meetings with the report on the manager calendar in response to the report leaving the organization or the report leaving the team of the manager.

7. The method of claim 1, wherein the meeting is a one-on-one meeting between the manager and the report that focuses on day-to-day activities of the report, career growth of the report, or future goals for the report.

8. A method, comprising:
period;
tracking a plurality of meetings between a manager and a report during a time obtaining meeting minutes for each meeting of the plurality of meetings;
analyzing the meeting minutes of the plurality of meetings using a machine learning model; and
automatically generating feedback for the report or the manager based on analyzing the meeting minutes.

9. The method of claim 8, wherein obtaining the meeting minutes for the meeting further includes automatically obtaining the meeting minutes for the meeting from a transcript generated for the meeting.

10. The method of claim 8, wherein obtaining the meeting minutes for the meeting further includes:
automatically sending a message with a template for the manager or the report to provide information for the meeting minutes.

11. The method of claim 8, wherein analyzing the meeting minutes further includes aggregating a performance of the report or the manager during the time period from information provided in the meeting minutes.

12. The method of claim 8, wherein analyzing the meeting minutes further includes:
automatically identifying one or more action items for the report from the meeting minutes; and
tracking completion of the one or more action items.

13. The method of claim 8, wherein the time period is a review cycle, and the feedback is provided during a review of the report or the manager.

14. The method of claim 8, wherein the feedback provides a holistic view of a performance of the report or the manager over the time period.

15. A device, comprising:
one or more processors;
memory in electronic communication with the one or more processors; and
instructions stored in the memory, the instructions executable by the one or more processors to:
track a plurality of meetings between a manager and a report during a time period;
obtain meeting minutes for each meeting of the plurality of meetings;
analyze the meeting minutes of the plurality of meetings using a machine learning model; and
automatically generate feedback for the report or the manager based on analyzing the meeting minutes.

16. The device of claim 15, wherein the instructions are executable by the one or more processors to obtain the meeting minutes for the meeting by automatically obtaining the meeting minutes for the meeting from a transcript generated for the meeting.

17. The device of claim 15, wherein the instructions are executable by the one or more processors to obtain the meeting minutes for the meeting by automatically sending a message with a template for the manager or the report to provide information for the meeting minutes.

18. The device of claim 15, wherein the instructions are executable by the one or more processors to analyze the meeting minutes by aggregating a performance of the report or the manager during the time period from information provided in the meeting minutes.

19. The device of claim 15, wherein the instructions are executable by the one or more processors to analyze the meeting minutes by:
automatically identifying one or more action items for the report from the meeting minutes; and
tracking completion of the one or more action items.

20. The device of claim 15, wherein the time period is a review cycle, and the feedback is provided during a review of the report or the manager and the feedback provides a holistic view of a performance of the report or the manager over the time period.
